(19) United States
(12) Patent Application Publication
(10) Pub. No.: US 2017/0143164 A1
(43) Pub. Date: May 25, 2017

(54) APPARATUS AND METHOD FOR MARINATING A VEGETABLE

(71) Applicant: Jefferey Cook, Columbus, MS (US)

(72) Inventor: Jefferey Cook, Columbus, MS (US)

(21) Appl. No.: 14/947,200

(22) Filed: Nov. 20, 2015

(51) Int. Cl. A47J 43/00

(52) U.S. Cl. CPC A47J 43/00; A23L 1/2123; A23V 2002/00

(57) ABSTRACT

A drilling apparatus used in the process of marinating a vegetable such as corn on the cob is provided. A rigid sleeve is slidably attached to the shank of a drill bit. The sleeve is resiliently biased toward a cutting head at one end of the shank. An end of an ear of corn is inserted into the sleeve and a hole is drilled in the corn cob as the shank slides through an opening in the sleeve into the corn cob. The sleeve keeps the drill bit aligned with the corn cob and protects the user's hand. Once the hole is drilled, a marinade is injected into the hole and a small dowel is used to plug the hole. The corn is then allowed to marinate before cooking. The marinade penetrates the corn cob and infuses an improved flavor in the kernels of corn.

### FIELD OF THE INVENTION

A preferred embodiment of the present invention refers to an apparatus and method for marinating a vegetable.

### BACKGROUND

Many different types of foods, including both meats and vegetables, can be marinated to improve their flavor. Food is typically allowed to sit in a marinade containing various herbs and/or spices for a period of time to allow the food to become infused with the flavors of the herbs and/or spices contained in the marinade. However, some foods do not absorb flavors as easily as others. For instance, the flavor of corn on the cob cannot be effectively improved simply by applying a marinade to whole ears of corn on the cob because the marinade does not effectively penetrate the corn as compared to other types of food. Sometimes a marinade may be injected into food to facilitate infusion of the marinade in the food. However, because corn cobs are hard substances that are not eaten, typical marinade injection methods cannot be effectively utilized to improve the flavor of the corn.

Accordingly, there is clearly a need in the art for an improved apparatus and method for marinating a vegetable such as corn on the cob in order to improve the flavor of the vegetable.

In addition, there is a need in the art for an apparatus and method that can be used to improve the flavor of corn while the corn kernels are still on the cob so that the corn can be eaten directly off the cob.

### SUMMARY

A preferred embodiment of the invention is directed to a drilling apparatus configured for drilling a hole in a vegetable so that a marinade can be injected into the hole. The apparatus is particularly advantageous when used to drill a hole in the cob of an ear of corn on the cob, though it may also be utilized with other vegetables. The injected marinade penetrates the corn cob internally and infuses an improved flavor in the kernels of corn attached to the cob. The hole is drilled longitudinally along a substantial portion of the length of the cob to effectively distribute marinade throughout the ear of corn.

The drilling apparatus is configured to allow a user to quickly and easily drill a hole in a corn cob or other vegetable. The drilling apparatus comprises a drill bit and a rigid sleeve attached thereto. The drill bit comprises a shank having a cutting head attached to one end of the shank. The rigid sleeve is slidably attached to the shank such that the sleeve can slide along a length of the shank. The sleeve is resiliently biased toward the end of the shank having the cutting head attached thereto. The sleeve surrounds one end of an ear of corn and keeps the ear of corn aligned with the drill bit when drilling the hole. As the drill bit penetrates the corn cob to drill the hole, the sleeve slides down the shank. Thus, the sleeve keeps the ear of corn aligned with the drill bit and guides the drill bit in order to drill a hole that is longitudinally aligned with the center of the of corn cob. The sleeve also protects the user from injury by preventing the drill bit from sliding off the ear of corn and potentially cutting the user's hand as the user is drilling the hole. Once the hole is drilled, a marinade is injected into the hole to marinate the ear of corn before cooking.

Accordingly, one object of the present invention is to provide an apparatus and method for marinating vegetable such as corn on the cob in order to improve the flavor of the vegetable.

Another object of the present invention is to provide an apparatus and method that can be used to improve the flavor of corn while the corn kernels are still on the cob so that the corn can be eaten directly off the cob.

Another object of the present invention is to provide an apparatus and method for drilling a hole in a vegetable such as corn on the cob for injecting a marinade.

Another object of the present invention is to provide an apparatus and method that allows a user to easily drill a hole in a vegetable such as corn on the cob while keeping the vegetable aligned with the drill bit.

Another object of the present invention is to provide an apparatus and method for drilling a hole in a vegetable such as corn on the cob that protects the user from injury from the drill bit.

### DESCRIPTION OF THE DRAWINGS

These and other features, aspects, and advantages of the present invention will become better understood with regard to the following description, appended claims, and accompanying drawings where:

FIG. 1 depicts a side elevational view of an apparatus embodying features of the present invention.

FIG. 2 shows a top perspective view of an apparatus embodying features of the present invention.

FIG. 3 shows a side perspective view of an apparatus embodying features of the present invention.

FIG. 4A shows a perspective view of a user using an apparatus embodying features of the present invention.

FIG. 4B shows a perspective view of a user using an apparatus embodying features of the present invention.

FIG. 4C shows a perspective view of a user using an apparatus embodying features of the present invention.

FIG. 5 shows an exemplary vegetable having a hole drilled therein using an apparatus embodying features of the present invention.

FIG. 6 shows a perspective view of an exemplary embodiment of an injector that may be utilized with the present invention.

FIG. 7 shows a perspective view of an exemplary embodiment of a dowel that may be utilized with the present invention.

FIG. 8 shows a perspective view of an exemplary embodiment of an insert that may be utilized with the present invention.

FIG. 9 shows a perspective view of an exemplary embodiment of a handle that may be utilized with the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

A preferred embodiment of the invention is directed to a drilling apparatus configured for drilling a hole in a vegetable so that a marinade can be injected into the hole. The apparatus is particularly advantageous when used to drill a hole in the cob of an ear of corn on the cob, though it may be utilized with other vegetables. The device is particularly suitable for use with various types of elongated vegetables, including, but not limited to, cucumbers, zucchini, potatoes, carrots, squash, and radishes. When used with corn on the cob, the injected marinade penetrates the corn cob internally and infuses an improved flavor in the kernels of corn attached to the cob. The hole is drill longitudinally along a substantial portion of the length of the cob to effectively distribute marinade throughout the ear of corn. Any desired type of marinade may be utilized. Marinades typically contain various herbs and spices, though the term “marinade,” as used herein, may include any type of edible, liquefied food substance, including substances such as melted cheese, which may not contain herbs or spices.

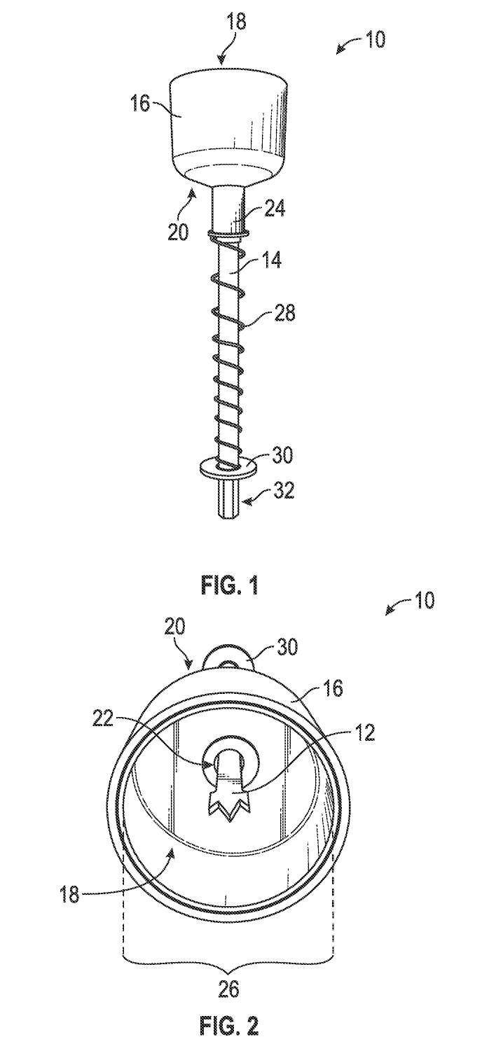

Turning now to the drawings, FIGS. 1-3 illustrate a preferred embodiment of the present invention. As illustrated in FIGS. 1-2, the drilling apparatus comprises a drill bit 10 and a sleeve 16 attached thereto. The drill bit 10 comprises a shank 14 having a cutting head 12 attached to one end of the shank 14. The sleeve 16 is made of a rigid material, such as a hard plastic material, and is slidably attached to the shank 14 such that the sleeve 16 can easily slide along a length of the shank 14.

The sleeve 16 preferably has a circular cross sectional shape, though other shapes may be utilized, such as a polygonal shape. The sleeve 16 has an open end 18 and a closed end 20, thereby forming a shape similar to that of a circular cup. The sleeve 16 has a hole 22 extending through the closed end 20. As shown in FIG. 2, the hole 22 is located at approximately the center point of the circular cross sectional area of the closed end 20 of the sleeve 16. The shank 14 of the drill bit 10 extends through the hole 22 such that the sleeve 16 is slidably attached to the shank 14. As shown in FIG. 2, the open end 18 of the sleeve 16 is oriented in the same direction as the cutting head 12. In a preferred embodiment, as shown in FIG. 1, the sleeve further comprises an extension 24 extending in an axial direction along a short length of the shank 14 from the hole 22 in the closed end in order to provide added support to the sleeve 16 and keep the sleeve 16 aligned with the shank 14 of the drill bit 10.

In a preferred embodiment, the sleeve 16 is resiliently biased toward the end of the shank 14 having the cutting head 12 attached thereto. As shown in FIG. 1, the drilling apparatus preferably comprises a coil spring 28 coiled around the shank 14. The spring 28 has two ends. One end is attached to the extension 24 of the sleeve 16, and the opposite end may be unattached or may be attached to a contacting surface 30 attached to the shank 14. Thus, the spring 28 is positioned between the contacting surface 30 and the sleeve 16. The contacting surface 30 is preferably circular and extends outward from the shank 14 in a radial direction. The contacting surface 30 maintains a force between the contacting surface 30 and the sleeve 16 such that the force causes the sleeve 16 to be resiliently biased toward the end of the shank 14 having the cutting head 12 attached thereto. When a force causes the sleeve 16 to slide along the shank 14 toward the contacting surface 30, the contacting surface causes the spring 28 to compress. When the force is released, the sleeve 16 slides back to its original position, as shown in FIGS. 1-2. Although a coil spring is preferred, it should be understood that any means known in the art for resiliently biasing the sleeve may be utilized and still fall within the scope of the present invention.

The drilling apparatus may optionally comprise a piece of fabric that covers the spring 28 as the spring is compressed and released during use.

As shown in FIG. 2, the cutting head 12 is preferably a spade-type drill bit head having a flat bit with a centering point and two spurs on either side of the centering point. The cutting head 12 preferably has a diameter larger than the diameter of the hole 22 in the closed end 20 of the sleeve 16. Thus, the sleeve 16 can not slide off the shank 14 because the cutting head 12 can not pass through the hole 22. However, it should be understood that any type of drill bit having cutting edges may be utilized and still fall within the scope of the present invention. As used herein, the term “head” or “cutting head” refers to the portion of a drill bit having cutting edges and may include drill bits having a constant diameter throughout the cutting edges and the shank.

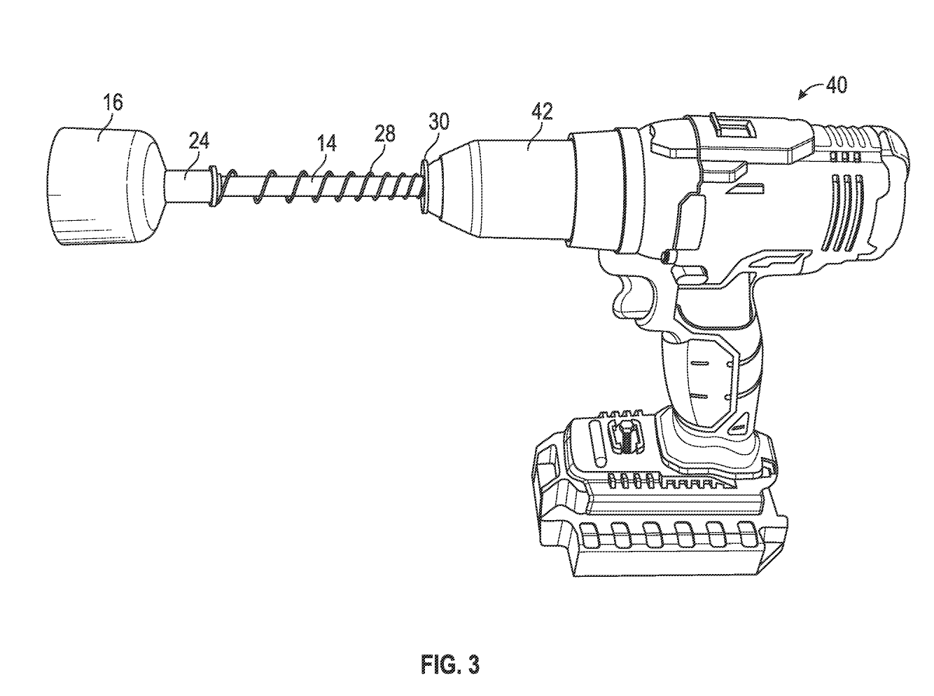

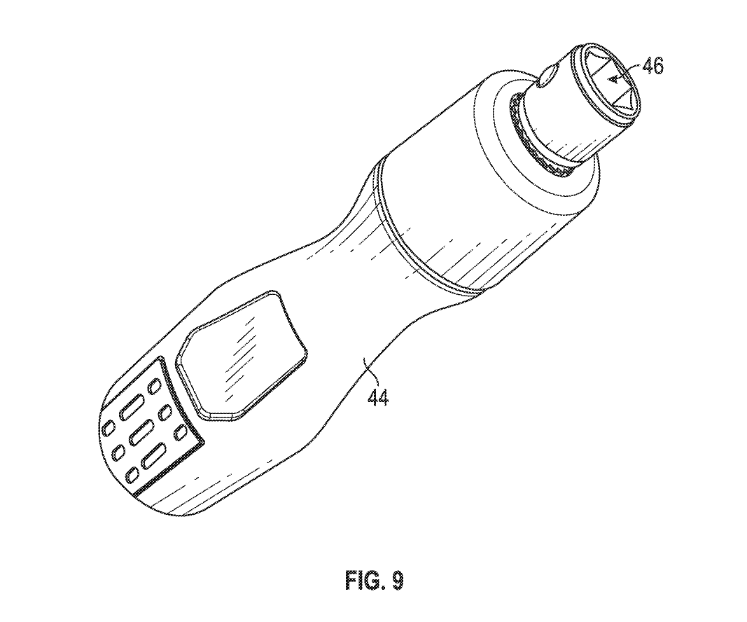

The shank 14 comprises a lower portion 32 located below the contacting surface 30, as shown in FIG. 1. The lower portion 32 is used for attaching the shank 14 to a device for applying torque to the shank 14. In a preferred embodiment, any commercially available electric or battery powered drill may be utilized. As shown in FIG. 3, the drill 40 has a chuck 42 configured for attaching the shank 14 to the chuck 42. The lower portion 32 of the shank 14 is inserted into the chuck 42 until the contacting surface 30 contacts the chuck 42. The chuck 42 is then tightened to secure the shank 14 to the drill 40. In one embodiment, the entire shank 14 has a circular cross sectional shape. In a preferred embodiment, as shown in FIG. 1, the lower portion 32 of the shank 14 has a polygonal cross sectional shape, and preferably a hexagonal cross sectional shape. The hexagonal shape allows the shank 16 to be attached to a chuck 42 on a power drill 40 or optionally to a handle 44 for applying torque manually if a power drill is unavailable. The handle 44 is configured for attaching the shank 14 to the handle 44 such that torque can be applied to the shank 14 by turning the handle 44. In a preferred embodiment, as shown in FIG. 9, the handle 44 has a hexagonal socket 46 that is compatible with the hexagonal lower portion 32 of the shank 14 such that the lower portion 32 can be inserted into the socket 46 to attach the shank 14 to the handle 44.

In a preferred embodiment, the shank 14 and the cutting head 12 are chrome plated or made of stainless steel or a similar material that is resistant to rusting such that the drilling apparatus may be washed in a dishwashing machine. Additionally, the sleeve 16 is preferably made of a hard plastic or other similar material that is dishwasher safe.

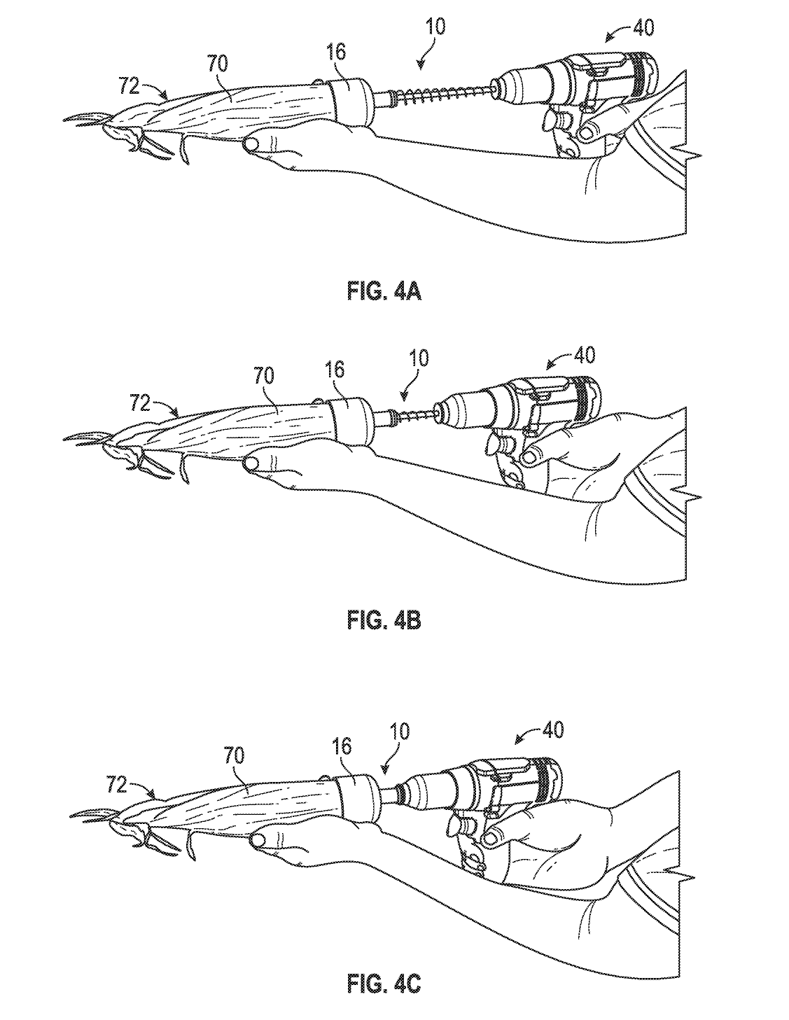

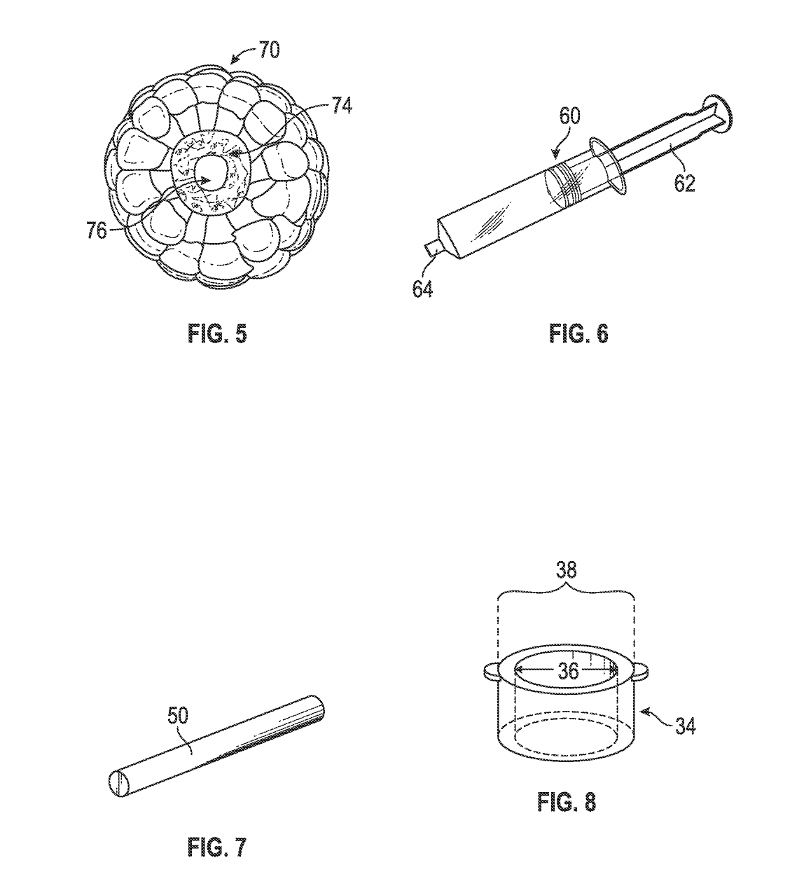

As illustrated in FIGS. 4A-4C and FIG. 5, the drilling apparatus is configured to allow a user to quickly and easily drill a hole in the cob 74 of an ear of corn 70 or other vegetable for marinating the corn or other vegetable. When used with corn 70, the corn may or may not have the husk 72 removed, depending on the preference of the user. As shown in FIG. 4A, one end of the ear of corn 70 is inserted into the open end 18 of the sleeve 16 so that the head 12 of the drill bit 10 contacts the corn cob 74. The end of the corn 70 inserted should be an end at which the cob 74 is exposed, as shown in FIG. 5. Torque is then applied to the drill bit 10 to drill a hole 76 in the cob. Torque may be applied either by a power drill 40 or manually by a handle 44 attached to the drill bit 10. When drilling the hole 76, the user can hold the corn 70 and the sleeve 16 together, as shown in FIGS. 4A-4C, in order to protect the user's hand from injury by preventing the head 12 of the drill bit 10 from sliding off the ear of corn 70 and potentially cutting the user's hand.

As shown in FIGS. 4B-4C, the user inserts the drill bit 10 as the hole 76 is drilled. This action causes the sleeve 16 to slide down the shank 14 and compress the spring 28. The shank 14 is sized such that the spring 28 can be fully compressed without the head 12 exiting the opposite side of an average sized ear of corn 70. Thus, the hole 76 is open at only one end. In a preferred embodiment, the combined length of the shank 14 and the head 12 is approximately 8.5 inches long. For shorter ears of corn or other vegetables, the user can stop drilling before the spring is fully compressed.

FIG. 5 shows one end of an ear of corn 70 in which a hole 76 has been drilled into the cob 74. The hole 76 is drill longitudinally along a substantial portion of the length of the cob 74 to effectively distribute marinade throughout the ear of corn 70. The sleeve 16 allows the user to keep the ear of corn 70 aligned with the drill bit 10 and guides the drill bit 10 in order to drill a hole 76 that is longitudinally aligned with the center of the of corn cob 74. In a preferred embodiment, the cutting head 12 has a diameter of approximately ⅜ inches to produce an appropriately sized hole 76, though the diameter may be varied as desired. Once the hole 76 is drilled, a marinade is injected into the hole 76 to marinate the ear of corn 70 before cooking.

The present invention further comprises a kit used for marinating an ear of corn 70 or other vegetable. The kit comprises the drilling apparatus as described above as well as other components. As shown in FIG. 6, the kit includes an injector 60 having a plunger 62 and a nozzle 64. The nozzle 64 is sized such that it can be inserted into the hole 76 to inject the marinade. Optionally, the injector 60 may be pre-packaged with a marinade sealed inside. The user may then break the seal and use the plunger 62 to inject the pre-packaged marinade into the corn. In one embodiment, the kit may include a variety of pre-packaged marinades.

As shown in FIG. 7, the kit further comprises a dowel 50 having a diameter approximately equal to the diameter of the cutting head 12. The dowel 50 is used to plug the hole 76 in the corn cob 74 after injecting the marinade in order to keep the marinade inside the hole 76 during marinating and cooking. A portion of the dowel 50 may be left protruding from the hole 76 in order to function as a handle for holding and eating the corn. Alternatively, a separate handle may be attached to one end of the dowel 50 for this purpose.

As shown in FIG. 8, the kit further comprises an insert 34 for adjusting the size of the sleeve. The open end 18 of the sleeve 16 has a diameter 26, and the insert 34 is configured for reducing the diameter 26 of the open end 18. In a preferred embodiment, the insert 34 has an internal diameter 36 and an external diameter 38. The internal diameter 36 is smaller than the diameter 26 of the open end 18 of the sleeve 16, and the external diameter 38 of the insert 34 is sized such that the insert 34 can be firmly secured to the sleeve 16 by inserting the insert 34 into the open end 18 of the sleeve 16. Thus, the insert 34 may be used to accommodate smaller ears of corn 70 or other smaller vegetables. In a preferred embodiment, the diameter 26 of the open end 18 of the sleeve 16 is approximately 2⅜ inches, and the internal diameter 36 of the insert 34 is approximately 2 inches. The kit may comprise additional inserts of various sizes.

The kit may optionally comprise a handle 44 for attachment to the shank 14 of the drill bit 10 as previously described or a powered drilling device such as the drill 40 illustrated in FIG. 3.

It is understood that versions of the invention may come in different forms and embodiments. Additionally, it is understood that one of skill in the art would appreciate these various forms and embodiments as falling within the scope of the invention as disclosed herein.

What is claimed is:

1.) A drilling apparatus, comprising:
a. a drill bit comprising a shank having a cutting head attached to one end of the shank; and
b. a rigid sleeve slidably attached to the shank, said sleeve having an open end and a closed end, wherein the closed end has a hole therethrough, wherein the shank extends through the hole such that the sleeve can slide along a length of the shank, and wherein the open end of the sleeve is oriented in the same direction as the cutting head.

2.) The drilling apparatus of claim 1, wherein the sleeve is resiliently biased toward the end of the shank having the cutting head attached thereto.

3.) The drilling apparatus of claim 2, further comprising a coil spring coiled around the shank, wherein the spring is configured to cause the sleeve to be resiliently biased toward the end of the shank having the cutting head attached thereto.

4.) The drilling apparatus of claim 3, wherein the coil spring is positioned between the rigid sleeve and a contacting surface attached to the shank of the drill bit for compressing the spring.

5.) The drilling apparatus of claim 1, wherein the cutting head has a diameter larger than the diameter of the hole in the closed end of the sleeve.

6.) The drilling apparatus of claim 1, wherein the open end of the sleeve has a diameter, said drilling apparatus further comprising an insert configured for reducing the diameter of the open end.

7.) The drilling apparatus of claim 6, said insert having an internal diameter smaller than the diameter of the open end of the sleeve and an external diameter sized such that the insert can be firmly secured to the sleeve by inserting the insert into the open end of the sleeve.

8.) The drilling apparatus of claim 1, further comprising a drill having a chuck configured for attaching the shank of the drill bit to the chuck such that torque can be applied to the drill bit.

9.) The drilling apparatus of claim 1, further comprising a handle configured for attaching the handle to the shank of the drill bit such that torque can be applied to the drill bit manually.

10.) A kit, comprising:
a. a drilling apparatus, comprising:
i. a drill bit comprising a shank having a cutting head attached to one end of the shank; and
ii. a rigid sleeve slidably attached to the shank, said sleeve having an open end and a closed end, wherein the open end has a diameter and the closed end has a hole therethrough, wherein the shank extends through the hole such that the sleeve can slide along a length of the shank, and wherein the open end of the sleeve is oriented in the same direction as the cutting head;
b. a dowel having a diameter approximately equal to the diameter of the cutting head;
c. an injector; and
d. an insert configured for reducing the diameter of the open end of the sleeve.

11.) The kit of claim 10, wherein the sleeve is resiliently biased toward the end of the shank having the cutting head attached thereto.

12.) The kit of claim 11, wherein the drilling apparatus further comprises a coil spring coiled around the shank, wherein the spring is configured to cause the sleeve to be resiliently biased toward the end of the shank having the cutting head attached thereto.

13.) The kit of claim 10, wherein the insert has an internal diameter smaller than the diameter of the open end of the sleeve and an external diameter sized such that the insert can be firmly secured to the sleeve by inserting the insert into the open end of the sleeve.

14.) The kit of claim 10, further comprising a handle configured for attaching the handle to the shank of the drill bit such that torque can be applied to the drill bit manually.

15.) A method of marinating a vegetable, said method comprising the steps of:
a. providing a drilling apparatus, comprising:
i. a drill bit comprising a shank having a cutting head attached to one end of the shank; and
ii. a rigid sleeve slidably attached to the shank, said sleeve having an open end and a closed end, wherein the closed end has a hole therethrough, wherein the shank extends through the hole such that the sleeve can slide along a length of the shank, and wherein the open end of the sleeve is oriented in the same direction as the cutting head;
b. inserting a vegetable into the open end of the sleeve such that the cutting head of the drill bit contacts the vegetable;
c. applying torque to the drill bit such that the cutting head drills a hole into the vegetable, wherein the hole in the vegetable is open at only one end; and
d. injecting a marinade into the open end of the hole in the vegetable.

16.) The method of claim 15, wherein the vegetable is corn on the cob and the hole is drilled longitudinally into the corn cob.

17.) The method of claim 15, further comprising the step of plugging the open end of the hole in the vegetable after injecting the marinade.

18.) The method of claim 15, wherein the step of applying torque to the drill bit comprises attaching the shank of the drill bit to an electric drill and operating the electric drill to apply torque to the shank.

19.) The method of claim 15, wherein the drilling apparatus further comprises a coil spring coiled around the shank, wherein the spring is configured to cause the sleeve to be resiliently biased toward the end of the shank having the cutting head attached thereto.

20.) The method of claim 15, wherein the cutting head has a diameter larger than the diameter of the hole in the closed end of the sleeve.
